(19) United States
(12) Patent Application Publication
(10) Pub. No.: US 2025/0218753 A1
(43) Pub. Date: Jul. 3, 2025

(54) MASS SPECTROMETER HAVING HIGH DUTY CYCLE

(71) Applicant: Micromass UK Limited, Wilmslow (GB)

(72) Inventor: Jason Wildgoose, Stockport (GB)

(73) Assignee: Micromass UK Limited, Wilmslow (GB)

(21) Appl. No.: 18/850,007

(22) PCT Filed: Mar. 20, 2023
(86) PCT No.: PCT/GB2023/050685

§ 371 Date: Sep. 23, 2024

(30) Foreign Application Priority Data
Mar. 23, 2022 (GB) 2204104.0

(51) Int. Cl. H01J 49/00; H01J 49/40

(52) U.S. Cl. CPC H01J 49/0031; H01J 49/0036; H01J 49/401

(57) ABSTRACT

A method of mass spectrometry comprising: a) providing a mass spectrometer having a time of flight (TOP) mass analyser: b) performing a survey scan comprising separating a packet of precursor ion species and mass analysing ions so as to obtain first mass spectral data: c) determining a time window over which one of the precursor ion species. or fragment or product ions derived therefrom, were mass analysed: d) separating another packet of precursor ion species and mass analysing ions so as to obtain second mass spectral data. wherein the pusher of the TOP mass analyser is pulsed according to a plurality of consecutive pulse sequences during a plurality of respective pulse sequence time periods. wherein each pulse sequence consists of consecutive pushes that are arranged such that the duration between any pair of pushes in the pulse sequence is different to the duration between any other pair of pushes within the pulse sequence: f) selecting mass spectral data, from the second mass spectral data, that was obtained during a time period corresponding to said time window of the survey scan, so as to obtain selected data; g) repeating steps d) to f) at least one further time such that multiple sets of said selected data are obtained; combining said multiple sets of selected data and decoding the combined data to obtain mass spectral data representative of the mass to charge ratios of the ions detected by the TOP mass analyser.

### CROSS-REFERENCE TO RELATED APPLICATION

This application claims priority from and the benefit of United Kingdom patent application No. 2204104.0 filed on 23 Mar. 2022. The entire content of this application is incorporated herein by reference.

### FIELD OF THE INVENTION

The present invention relates generally to mass spectrometers that repeatedly pulse ions into a separation region so as to cause the ions to separate according to mass to charge ratio.

### BACKGROUND

In both Data Dependent Acquisition (DDA) and tandem (MSMS) mass spectrometry, precursor ions are filtered such that only a selected species of precursor ion is transmitted downstream for analysis at any given time. The mass spectrometer then selects a different species of precursor ion to be transmitted downstream for analysis. This process continues until the desired species of precursor ions have been analysed. It is generally desirable to sequentially select and transmit as many precursor ions per unit time as possible, in order to analyse the sample as fast as possible. However, on conventional instruments, such as quadrupole-Time of Flight (QToF) mass spectrometers, simply speeding up the rate at which precursor species are selected results in a linear drop in sensitivity for the ions that are detected. For example, if the spectrometer settings are changed such that the number of precursor species that are transmitted increases from 25 different precursors per second to 50 different precursors per second then this leads to half the number of ions in each fragment ion scan.

It is desired to increase the overall duty cycle of such instruments.

### SUMMARY

A first aspect of the present disclosure provides a method of mass spectrometry comprising: a) providing a mass spectrometer having an ion separator for separating ions according to a physicochemical property, and a time of flight (TOF) mass analyser having an ion detector and a pusher that, when pulsed, pushes ions into a time of flight region to a detector; b) performing a survey scan comprising: performing a separation cycle during which a packet of precursor ion species is separated in the ion separator such that precursor ion species having different values of the physicochemical property elute from the ion separator at different times; and then mass analysing the separated precursor ion species, or fragment or product ions derived therefrom, in the TOF mass analyser so as to obtain first mass spectral data; c) determining, from the first mass spectral data, a time window over which one of the precursor ion species, or fragment or product ions derived therefrom, were mass analysed by the TOF mass analyser; d) performing another separation cycle during which another packet of precursor ion species is separated in the ion separator such that precursor ion species having different values of the physicochemical property elute from the ion separator at different times; and then e) mass analysing the precursor ion species separated in step d), or fragment or product ions derived therefrom, in the TOF mass analyser so as to obtain second mass spectral data, wherein this mass analysing comprises pulsing the pusher according to a plurality of consecutive pulse sequences during a plurality of respective pulse sequence time periods, wherein each pulse sequence consists of consecutive pushes that are arranged such that the duration between any pair of pushes in the pulse sequence is different to the duration between any other pair of pushes within the pulse sequence; f) selecting mass spectral data, from the second mass spectral data, that was obtained during a time period corresponding to said time window of the survey scan, so as to obtain selected data; g) repeating steps d) to f) at least one further time such that multiple sets of said selected data are obtained; h) combining said multiple sets of selected data so as to obtain combined data; and then i) decoding the combined data to obtain mass spectral data representative of the mass to charge ratios of the ions detected by the TOF mass analyser.

As mass spectral data for the same precursor ion species (or fragment or product ions derived therefrom) is selected from multiple separation cycles and combined, the number of ions occurring at a given time of flight (i.e. having a given mass to charge ratio) is more likely to reach a level required by the decoding process for determining that a mass peak is present. This is in contrast to known techniques, in which the mass spectral data obtained from a single separation cycle is decoded. In such known techniques ions may not be determined to be related to a mass peak if they have a low abundance. As the new techniques disclosed herein decode the data only after it has been combined, such drawbacks may be avoided.

Step c) may comprise determining a first time delay between the start time of the separation cycle in the survey scan and the start time of said time window; and the method may comprise setting said time period in step f) to begin after a second time delay from the start time of said another separation cycle in step d), wherein said first time delay is the same as the second time delay.

Said time window may have the same duration as said time period in step f).

Said step of selecting mass spectral data in step f) may comprise selecting only some of the mass spectral data obtained in step e). The other, non-selected mass spectral data obtained in step e) may be discarded or not selected to be combined with other data.

The selected mass spectral data obtained in step f) may include mass spectral data obtained during multiple different ones of the pulse sequence time periods of step e).

The multiple different pulse sequence time periods may be consecutive (i.e. immediately adjacent) pulse sequence time periods.

The combined data may be decoded based on knowledge of the pulse sequence used in each of said plurality of pulse sequence time periods.

All of the plurality of pulse sequences may consist of the same pulse sequence, i.e. the same pattern of pulses may be used for each and every one of the pulse sequences.

Said decoding may assign data corresponding to ions that have been detected to mass to charge ratios, and may determine that a mass to charge ratio peak has been detected only when more than a threshold number of ions are assigned to a given mass to charge ratio.

If fewer than the threshold number of ions are assigned to a given mass to charge ratio, then the data (from the combined data) for those ions may be discarded.

Optionally, the step of determining the time window in step c) comprises determining the time window during which only a single one of the precursor ion species, or fragment or product ions derived therefrom, arrives at and is mass analysed by the TOF mass analyser. The selected mass spectral data in step f) may therefore consist of only mass spectral data for said single one of the precursor ion species, or for fragment or product ions derived therefrom.

The method may comprise fragmenting or reacting precursor ion species in a fragmentation or reaction device between steps d) and e) so that said mass analysing in step e) comprises mass analysing the resulting fragment or product ions.

It will be appreciated that fragmenting or reacting any given precursor ion species may result in multiple different fragment or product ion species being formed. The TOF mass analyser may simultaneously mass analyse all of the different fragment or product species derived from any given precursor species.

The spectrometer may associate the mass spectral data representative of the mass to charge ratios of the fragment or product ions with their precursor ion. This may be done by associating the fragment or product ions with a precursor ion detected by the TOF mass analyser at the same time, or with the same intensity profile, as these fragment or product ions (since some precursor ions may remain even after the fragmentation or reaction step). Alternatively, if the precursor ions are mass filtered so that different precursor ions are transmitted to the fragmentation or reaction device at different times, then the fragment or product ions may be associated with their precursor ions on the basis of their detection time.

Accordingly, the method may comprise separating precursor ions according to a physicochemical property, fragmenting or reacting the precursor ions so as to generate fragment or product ions, transmitting the fragment or product ions to the mass analyser such that fragment or product ions derived from different precursor ions are transmitted to the mass analyser over different time windows, and performing the step of mass analysing on the fragment or product ions.

The method may comprise providing a mass filter that filters ions between the ion separator and the fragmentation or reaction device so as to only transmit ions having a restricted value, or range of values, of mass to charge ratio at any given time; and controlling the mass filter to vary said value, or range of values, as ions elute from the ion separator so as to transmit different species of ions towards the fragmentation or reaction device at different times.

The mass filter may be controlled to vary said value, or range of values, over a cycle time that is synchronised with the separation cycle of step d).

The mass filter may be controlled in synchronism with the elution time of ions from said ion separator such that at any given time the mass filter is set to transmit mass to charge ratios that are expected to be arriving at the mass filter from the ion separator. For instance, where the ion separator is an ion mobility separator, the transit time of a given mass to charge ratio ion through the ion separator can be estimated (as mobility and mass to charge ratio are related) and used to control the mass filter to selectively transmit that mass to charge ratio as it exits the ion separator.

The mass filter is therefore able to be controlled to transmit one or more species of ion whilst other species of ion that are desired to be subsequently transmitted for analysis are still travelling through the ion separator toward the mass filter. As such, relatively few ions are discarded at the mass filter and the sensitivity of the analysis is relatively high. However, separating the ions in this manner may lead to relatively few ions arriving at the TOF mass analyser per unit time, which may lead to the problem described herein when using an Encoded Frequent Pulsing (EFP) technique. The present disclosure overcomes this by combining the EFP data in a new manner.

Where ions are fragmented or reacted, the separation of the precursor ions by the ion separator may be preserved in the fragment or product ions, such that fragment or product ions of different precursor ion species arrive at the TOF mass analyser over different, respective, times periods.

Each of the separation cycles described herein may be initiated by pulsing a packet of ions, comprising said precursor ion species, into the ion separator.

For example, ions may be accumulated in an ion accumulator and periodically pulsed into the ion separator. The ion separator performs the separation cycle between each pulse and the mass filter may be varied during each separation cycle as described above, e.g. in synchronism with the ion separator.

The first physicochemical property may be ion mobility.

For example, the ion separator may be a drift time ion mobility separator having electrodes and a voltage supply that maintains a static DC gradient that urges the ions through or against a background gas so as to cause the ions to separate according to their mobility through the gas. Alternatively, the ion separator may have electrodes and a voltage supply configured to repeatedly travel a DC or pseudo-potential barrier along the ion separator so as to urge ions through or against gas within the ion separator such that the ions are separated according to their mobility through the gas.

Alternatively, the first physicochemical property may be, for example, mass to charge ratio.

During the survey scan of step b), said mass analysing may comprise pulsing the pusher in a manner such that the duration between any pair of adjacent pusher pulses is equal to or greater than the time of flight from the pusher to the detector of the maximum mass to charge ratio ions that are pushed by the pusher. As such, the data obtained by the TOF mass analyser in the survey scan for multiple pushes is not multiplexed and does not require decoding.

It will be appreciated that the survey scan may process the ions in the same manner as the (non-survey scan) mode that has been described as being performed subsequent to the survey scan, except that the TOF mass analyser and TOF data is used differently in the two modes. In other words, if the non-survey scan mode includes the above-described mass filtering and/or fragmentation/reaction steps, then the survey scan mode may also include corresponding steps. This ensures that the time window identified in the survey scan corresponds to the duration at which said one of the precursor ion species, or fragment or product ions derived therefrom, are mass analysed in the TOF mass analyser during the non-survey scan.

The first aspect of the present disclosure also provides a mass spectrometer comprising: an ion separator for separating ions according to a physicochemical property; a time of flight (TOF) mass analyser having an ion detector and a pusher that, when pulsed, pushes ions into a time of flight region to a detector; and control circuitry configured to perform the method described herein.

The mass spectrometer may be configured to perform any of the methods described herein.

A second aspect of the present disclosure provides a method of mass spectrometry comprising: providing a time of flight (TOF) mass analyser having an ion detector and a pusher that, when pulsed, pushes ions into a time of flight region to the detector; mass analysing ions in the TOF mass analyser so as to obtain data relating to the ions, wherein said mass analysing comprises pulsing the pusher according to a pulse sequence that consists of consecutive pushes that are arranged such that the duration between any pair of pushes in the pulse sequence is different to the duration between any other pair of pushes within the pulse sequence; determining that one or more species of ions arrive at the TOF mass analyser during only a portion of one or more of the pulse sequence time periods; combining only data obtained by the mass analyser during said portion of the one or more pulse sequence time periods; and decoding this combined data.

It has been recognised that where a species of ions arrives at the TOF mass analyser over a time period that is shorter than a pulse sequence time period then it may not be desired to combine all of the TOF data obtained in that time period prior to the decoding step. For example, combining the TOF data obtained over the whole pulse sequence time period will combine more noise data than is necessary, since the ions are not present in the TOF mass analyser during the whole pulse sequence time period.

The method may comprise performing a survey scan, prior to said step of mass analysing ions, in which said one or more species of ions are mass analysed by the TOF mass analyser; determining a time window over which the one or more species of ions arrive at the TOF mass analyser from the survey scan; and using said time window to determine the portion of the one or more of the pulse sequence time periods during which the one or more species of ions arrive at the TOF mass analyser.

The second aspect of the present disclosure also provides a TOF mass analyser comprising: an ion detector and a pusher that, when pulsed, pushes ions into a time of flight region to the detector; and control circuitry configured to: mass analyse ions, so as to obtain data relating to the ions, by pulsing the pusher according to a plurality of consecutive pulse sequences during a plurality of respective pulse sequence time periods, wherein each pulse sequence consists of consecutive pushes that are arranged such that the duration between any pair of pushes in the pulse sequence is different to the duration between any other pair of pushes within the pulse sequence; determine that one or more species of ions arrive at the TOF mass analyser during only a portion of one or more of the pulse sequence time periods; combine only data obtained by the mass analyser during said portion of the one or more pulse sequence time periods; and decode the combined data to obtain mass spectral data representative of the mass to charge ratios of the one or more species.

The TOF mass analyser may be configured to perform any of the methods described in relation to the second aspect of the present disclosure.

The present disclosure also provides a mass spectrometer comprising the TOF mass analyser according to the second aspect of the present disclosure.

A third aspect of the invention provides a method of mass spectrometry comprising: (i) providing a time of flight (TOF) mass analyser having an ion detector and a pusher that, when pulsed, pushes ions into a time of flight region to the detector; (ii) mass analysing ions in the TOF mass analyser so as to obtain data relating to the ions, wherein said mass analysing comprises pulsing the pusher according to a plurality of consecutive pulse sequences during a plurality of respective pulse sequence time periods, wherein each pulse sequence consists of consecutive pushes that are arranged such that the duration between any pair of pushes in the pulse sequence is different to the duration between any other pair of pushes within the pulse sequence; (iii) combining the data obtained during multiple different ones of the pulse sequence time periods to obtain combined data; and then (iv) decoding the combined data to obtain mass spectral data representative of the mass to charge ratios of the ions.

As data from the multiple pulse sequence time periods is combined, the number of ions occurring at a given time of flight (i.e. having a given mass to charge ratio) is more likely to reach a level required by the decoding process for determining that a mass peak is present. This is in contrast to known techniques, in which the data obtained in a single pulse sequence time period is decoded. In such known techniques ions may not be determined to be related to a mass peak if they have a low abundance. As the new techniques disclosed herein decode the data only after it has been combined, such drawbacks may be avoided.

The combined data may be decoded based on knowledge of the pulse sequence used in each of said multiple pulse sequence time periods.

All of the plurality of pulse sequences may consist of the same pulse sequence, i.e. the same pattern of pulses may be used for each and every one of the pulse sequences.

Said decoding may assign data corresponding to ions that have been detected to mass to charge ratios, and determines that a mass to charge ratio peak has been detected only when more than a threshold number of ions are assigned to a given mass to charge ratio.

If fewer than the threshold number of ions are assigned to a given mass to charge ratio, then the data (from the combined data) for those ions may be discarded.

At least one species of ion may arrive at, and is mass analysed by, the TOF mass analyser over a time window that includes said multiple different pulse sequence time periods.

The multiple different pulse sequence time periods may be consecutive (i.e. immediately adjacent) pulse sequence time periods.

The method may combine data obtained during all of the pulse sequence time periods in which the at least one species of ion arrives at the TOF mass analyser (i.e. rather than only some of them) and then perform the decoding step on the resulting combined data.

At least one species of ion may arrive at the TOF mass analyser over a time window corresponding to at least one pulse sequence time period, and data obtained by the mass analyser during said at least one pulse sequence time period may be combined with data obtained by the mass analyser during the first pulse sequence time period that begins after a time that said at least one species of ion stops entering the TOF mass analyser.

The method may comprise fragmenting or reacting precursor ions upstream of the TOF mass analyser, and said step of mass analysing ions in the TOF mass analyser may comprise mass analysing the resulting fragment or product ions.

It will be appreciated that fragmenting or reacting any given precursor species may result in multiple different fragment or product ion species being formed. The TOF mass analyser may simultaneously analyse all of the different fragment or product species derived from any given precursor species.

The spectrometer may associate the mass spectral data representative of the mass to charge ratios of the fragment or product ions with their precursor ion. This may be done by associating the fragment or product ions with a precursor ion detected by the TOF mass analyser at the same time, or with the same intensity profile, as these fragment or product ions (since some precursor ions may remain even after the fragmentation or reaction step). Alternatively, if the precursor ions are mass filtered so that different precursor ions are transmitted to the fragmentation or reaction device at different times, then the fragment or product ions may be associated with their precursor ions on the basis of their detection time.

The method may comprise separating ions according to a physicochemical property, supplying the resulting separated ions to the mass analyser, and performing said step of mass analysing on these ions.

The method may comprise separating precursor ions according to a physicochemical property, fragmenting or reacting the precursor ions so as to generate fragment or product ions, transmitting the fragment or product ions to the mass analyser such that fragment or product ions derived from different precursor ions are transmitted to the mass analyser over different time windows, and performing said step of mass analysing on the fragment or product ions.

The physicochemical property may be, for example, ion mobility or mass to charge ratio. For example, the separator may be a drift time ion mobility separator having electrodes and a voltage supply that maintains a static DC gradient that urges the ions through a background gas so as to cause them to separate according to mobility. Alternatively, the separator may have electrodes and a voltage supply configured to repeatedly travel a DC or pseudo-potential barrier along the separator so as to urge ions through the separator such that they are separated according to mobility.

The method may comprise providing a mass filter that filters ions between the separator and the TOF mass analyser so as to only transmit ions having a restricted value, or range of values, of mass to charge ratio at any given time; and controlling the mass filter to vary said value, or range of values, as ions elute from the separator so as to transmit different species of ions towards the mass analyser at different times.

The mass filter may be controlled in synchronism with the elution time of ions from said separator.

For example, the mass filter may be controlled in synchronism with the elution time of ions from said separator such that at any given time the mass filter is set to transmit mass to charge ratios that are expected to be arriving at the mass filter from the separator. For instance, where the separator is an ion mobility separator, the transit time of a given mass to charge ratio ion through the separator can be estimated (as mobility and mass to charge ratio are related) and used to control the mass filter to selectively transmit that mass to charge ratio as it exits the separator.

The mass filter is therefore able to be controlled to transmit one or more species of ion whilst other species of ion that are desired to be subsequently transmitted for analysis are still travelling through the separator toward the mass filter. As such, relatively few ions are discarded at the mass filter and the sensitivity of the analysis is relatively high. However, separating the ions in this manner may lead to relatively few ions arriving at the TOF mass analyser per unit time, which may lead to the problem described herein when using an Encoded Frequent Pulsing (EFP) technique. The present disclosure overcomes this by combining the EFP data in a new manner.

The mass filter may be arranged between the separator and a fragmentation or reaction device that performs the above-described fragmentation or reaction.

Where ions are fragmented or reacted, the separation of the precursor ions by the separator may be preserved in the fragment or product ions, such that fragment or product ions of different precursor ions arrive at the TOF mass analyser at different times.

The method may comprise pulsing a packet of ions, comprising different species of ions, into the separator so as to begin said step of separating ions.

For example, ions may be accumulated in an ion accumulator and periodically pulsed into the separator. The separator performs a separation cycle between each pulse and the mass filter may be varied during each separation cycle as described above, e.g. in synchronism with the separator.

The method may comprise performing a survey scan, prior to said step of mass analysing ions, in which one or more species of ions are mass analysed by the TOF mass analyser; determining a time window over which the one or more species of ions arrive at the TOF mass analyser from the survey scan; and selecting said multiple different pulse sequence time periods based on the time window determined in the survey scan.

For example, at least part of each of the multiple different pulse sequence time periods may overlap with the time window. Alternatively, the method may comprise selecting at least one pulse sequence time period during which the one or more species arrive at the TOF mass analyser as one or more of said multiple different pulse sequence time periods, and selecting the first pulse sequence time period that begins after the time that said one or more species stops entering the TOF mass analyser as another of said one of said multiple different pulse sequence time periods.

These techniques of using survey scan data ensure data for the desired ion species are combined.

The method may comprise: mass analysing one or more further species of ion with the TOF mass analyser in the survey scan; determining a further time window over which the one or more further species of ions arrive at the TOF mass analyser from the survey scan; determining from said further time window that said one or more further species of ions arrive at the TOF mass analyser, during step (ii) of claim 1, during only a portion of one or more of the pulse sequence time periods; combining only data obtained by the mass analyser during said portion of the one or more pulse sequence time periods; and decoding this combined data.

It has been recognised that where a species of ions arrives at the TOF mass analyser over a time period that is shorter than a pulse sequence time period then it may not be desired to combine all of the TOF data obtained in that time period prior to the decoding step. For example, combining the TOF data obtained over the whole pulse sequence time period will combine more noise data than is necessary, since the ions are not present in the TOF mass analyser during the whole pulse sequence time period.

During the survey scan the TOF mass analyser may be operated in a mode such that the duration between any pair of adjacent pusher pulses is equal to or greater than the time of flight from the pusher to the detector of the maximum mass to charge ratio ions that are pushed by the pusher.

As such, the data obtained by the TOF mass analyser in the survey scan for multiple pushes is not multiplexed and does not require decoding.

It will be appreciated that in the embodiments where a survey scan is used, the survey scan may process the ions in the same manner as the non-survey scan mode described above except that TOF mass analyser and TOF data is used differently in the two modes. In other words, if the non-survey scan separates and/or filters and/or fragments ions then the survey scan may also include corresponding steps. This ensures that the times at which ions are determined to arrive at the TOF mass analyser in the survey scan correspond to the times that they will reach the TOF mass analyser in the non-survey scan. This information can then be used to select which data to combine in the non-survey mode.

The third aspect of the present disclosure also provides. a TOF mass analyser comprising: an ion detector and a pusher that, when pulsed, pushes ions into a time of flight region to the detector; and control circuitry configured to: mass analyse ions, so as to obtain data relating to the ions, by pulsing the pusher according to a plurality of consecutive pulse sequences during a plurality of respective pulse sequence time periods, wherein each pulse sequence consists of consecutive pushes that are arranged such that the duration between any pair of pushes in the pulse sequence is different to the duration between any other pair of pushes within the pulse sequence; combine the data obtained during multiple different ones of the pulse sequence time periods to obtain combined data; and then decode the combined data to obtain mass spectral data representative of the mass to charge ratios of the ions.

The TOF mass analyser may be configured to perform any of the methods described herein, e.g. in relation to the third aspect.

The present disclosure also provides a mass spectrometer comprising: an ion separator for separating ions according to a physicochemical property; a mass filter for mass filtering the separated ions received from the ion separator, wherein the mass filter is configured to transmit ions of different mass to charge ratios as ions elute from the ion separator; a fragmentation or reaction device for fragmenting or reacting ions received from the mass filter so as to produce fragment or product ions; and a TOF mass analyser as described above for mass analysing the fragment or product ions.

The mass spectrometer may be configured to perform any of the methods described herein, e.g. in relation to the third aspect.

### BRIEF DESCRIPTION OF THE DRAWINGS

Various embodiments of the present invention will now be described, by way of example only, and with reference to the accompanying drawings in which:

FIG. 1 shows a schematic of an embodiment of a mass spectrometer according to an embodiment of the present disclosure;

FIG. 2 shows how a mass filter may be controlled as a function of time so as to transmit precursor ions, according to an embodiment of the present disclosure;

FIG. 3 shows the same plot as FIG. 2, except also illustrating fragment or product ion species that may be generated from the precursor ions;

FIG. 4 shows an example of how ions may be mass analysed by a TOF mass analyser according to a non-Encoded Frequent Pulsing technique;

FIG. 5 shows an example of how ions may be mass analysed by a TOF mass analyser according to an Encoded Frequent Pulsing technique;

FIG. 6 illustrates a technique according to an embodiment of the present disclosure in which data obtained by a TOF mass analyser during multiple pulse sequence time periods is combined prior to decoding the data; and

FIG. 7 illustrates a technique according to an embodiment of the present disclosure in which only data obtained by a TOF mass analyser during a portion of a pulse sequence time period is combined prior to decoding the data.

### DETAILED DESCRIPTION

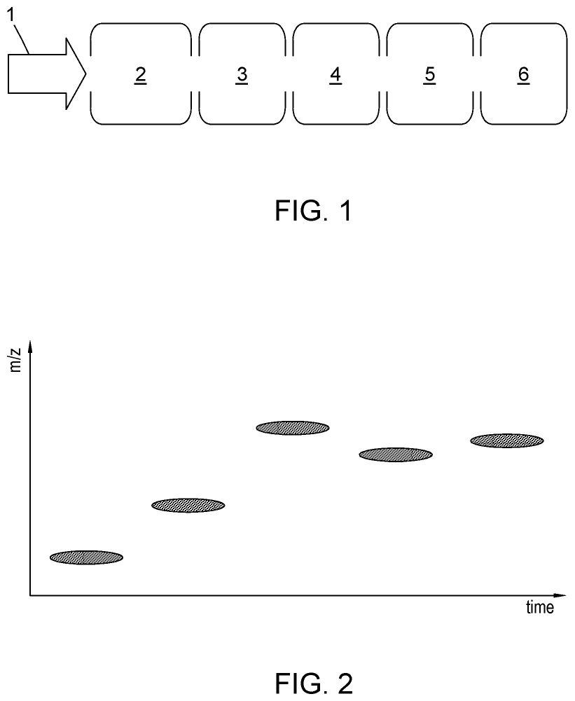

FIG. 1 shows a schematic of an embodiment of a mass spectrometer according to the present disclosure. The spectrometer comprises a source of ions 1, an ion accumulator 2, an ion separator 3, a mass filter 4, a fragmentation or reaction device 5 and a time of flight (TOF) mass analyser 6. It will be appreciated that other ion-optical devices may also be provided in the spectrometer, such as one or more RF ions guides, electrostatic lenses, or collisionally cooled RF ions guides that are configured to urge ions through them such as by using an axial electric field or by travelling electric potential barriers along them.

In use, ions are supplied from a source of ions 1, which may be an ion source that generates ions from an analytical sample, or may be an ion-optical device that supplies ions. The ions from the source 1 may be accumulated in the accumulator 2 and then released into the separator 3 as a packet of ions. The accumulator 2 may accumulate ions and periodically pulse them into the separator 3. The accumulator 2 may be configured to allow ions to continually enter it, or ions may be blocked from entering the accumulator 2 at the times that the packets of ions are being pulsed into the separator 3. Either way, the accumulator 2 accumulates ions from the source 1 in the time periods between the times at which packets of ions are pulsed into the separator 3. It is however contemplated that the accumulator 2 may be omitted and the source 1 may pulse ions into the separator 3 instead, e.g. by being a pulsed ion source or by providing an ion gate between the source 1 and the separator 3.

The separator 3 is controlled so as to cause each packet of ions received therein, e.g. from the accumulator 2, to be separated according to one or more physicochemical property. For example, the separator 3 may separate the ions according to ion mobility or mass to charge ratio, or a combination of both of these physicochemical properties. For instance, the separator 3 may be an ion mobility separator that drives ions against a gas so that the ions separate according to their mobility through the gas and elute from the separator at times that depend on their mobility through the gas. The separator 3 may drive ions through the gas using an electric field, such as that generated by a static DC gradient or by travelling DC potential barriers along the device, in the known manner. The gas may be substantially static, or the gas may flow in a direction opposite to the direction that the ions are urged by the electric field.

The separated ions then pass from the separator 3 to the mass filter 4. The mass filter 4 is controlled such that it is only able to transmit a single mass to charge ratio (or a restricted range of mass to charge ratios) at any given time, wherein the single mass to charge ratio (or the restricted range) is varied with time as the separated ions from the ion packet elute from the separator 3. The mass filter 4 may be varied in a manner that is synchronised with the separation cycle of the separator 3.

FIG. 2 represents an example of how the mass filter 4 may be controlled as a function of time, as the separated ions from the ion packet elute from the separator 3. More specifically, FIG. 2 shows a plot of the mass to charge ratios that are transmitted by the mass filter 4 as a function of time since the packet of ions was pulsed into the separator 3. In this example, the mass filter 4 is controlled such that at a first time it only transmits ions having a first, relatively low, mass to charge ratio. The mass filter is then controlled such that at a second, later time it only transmits ions having a second, higher mass to charge ratio. The mass filter is then controlled such that at a third, later time it only transmits ions having a third, higher mass to charge ratio. The mass filter is then controlled such that at a fourth, later time it only transmits ions having a fourth, lower mass to charge ratio. The mass filter is then controlled such that at a fifth, later time it only transmits ions having a fifth, higher mass to charge ratio.

The mass filter 4 may be, for example, a resolving quadrupole mass filter, although it is contemplated that other types of mass filter could be used. It will also be appreciated that the mass filter 4 may be controlled so as to transmit different mass to charge ratios at different times in manners other than those shown in the example of FIG. 2.

After a delay time since the packet of ions was pulsed into the separator 3, another packet of ions may be pulsed into the separator 3 and the above process may be repeated so as to separate and filter the ions in this next packet. The delay time may be the time it takes for all of the ions of interest (i.e. those that the filter 4 is set to transmit at some point in time) in one ion packet to pass through the separator 3 and to the filter 4, although it could be set to be a shorter or longer delay time if desired. Any desired number of ion packets may be sequentially separated and then filtered in the manner described above.

The separated ions that are transmitted by the filter 4 (i.e. rather than being filtered out by it) are transferred to the fragmentation or reaction device 5 and may be fragmented or reacted to produce fragment or product ions. The fragmentation or reaction device 5 may be a Collision Induced Dissociation (CID) device, an Electron Capture Dissociation (ECD) device, an Electron Transfer Dissociation (ETD) device, a Surface Induced Dissociation (SID), or a device that fragments ions according to any other technique. For example, the device may react the ions with reagent ions or molecules so as to cause the ions to fragment, or a device may be used to react the ions with reagent ions or molecules to form other types of product ions such as adduct ions.

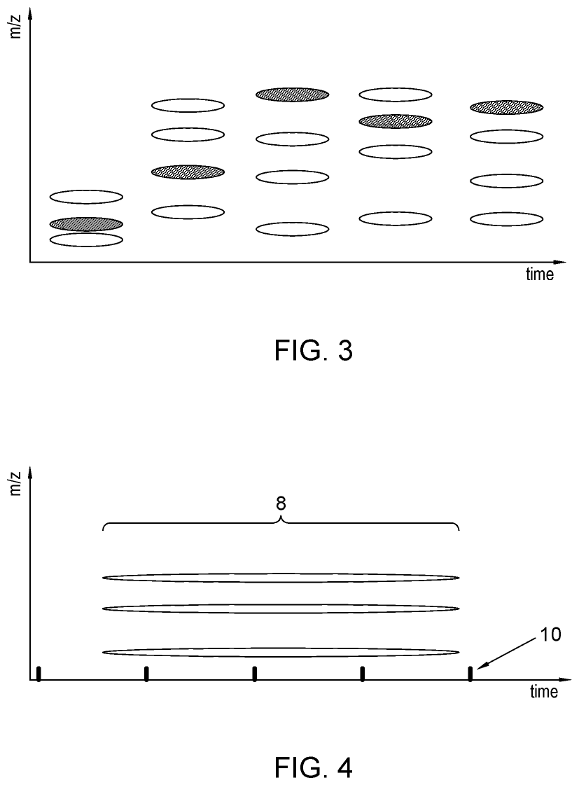

FIG. 3 shows the same plot as FIG. 2, except with the fragment or product ion species that are generated from the precursor ions superimposed. In the example shown, the first precursor species transmitted by the mass filter 4 is shown as the first dark oval and it has been fragmented or reacted to generate two species of fragment or product ions, which are shown by the lighter coloured ovals above and below the first dark oval. In this example, one of the fragment or product ion species has a higher mass to charge ratio than the first precursor species and the other has a lower mass to charge ratio. In this example, each of the second to fifth precursor species (which are represented by the dark ovals) is fragmented or reacted to generate three species of fragment or product ions (which are represented by the lighter ovals).

It will be appreciated that the different precursor ions arrive at the fragmentation or reaction device 5 at different times, due to their separation in the separator 3, and that therefore the different precursor ions are fragmented or reacted at different times so as to produce their fragment or product ions at different times. Although FIG. 3 shows the fragment or product ion species being generated over time periods that exactly align with the time period over which their precursor ion species is transmitted by the filter 4, it will be appreciated that this may not be the case and that the period over which any given fragment or product ion species is generated may be offset from the time at which its precursor ion species was transmitted by the filter 4, e.g. due to the transit time of the precursor ion species to (or through) the fragmentation or reaction device 5, and/or the time it takes for the precursor species to undergo fragmentation or reaction in the device 5.

The separation of the precursor ion species that was induced by the separator 3 may be preserved between the fragment or product ion species derived from these precursor ion species. In particular, the different precursor ion species arrive at the fragmentation or reaction device 5 at different times and so their respective fragment or product ion species are generated at corresponding different times. The fragment or product ion species may be urged out of the fragmentation or reaction device 5 such that the fragment or product ion species that are derived from different precursor species arrive at the TOF mass analyser 6 at different respective times.

Assuming lossless accumulation in the accumulator 2 and lossless ion transfer, the duty cycle and thus sensitivity for both precursor ions and hence fragment or product ions for the example shown in FIGS. 2 and 3 is over a factor of five better than traditional MSMS approaches that mass filter the precursor ions without accumulating and separating the ions upstream of the mass filter.

As described above, the fragment or product ions produced in the fragmentation or reaction device 5 are transferred to the TOF mass analyser 6. As is well known in the art, the TOF mass analyser 6 has a pusher that pulses a packet of ions into a time of flight region (e.g. a field-free region) and towards an ion detector. The ions separate out according to their mass to charge ratios, as they pass through the time of flight region, and then strike the ion detector. As such, the separated ions arrive at the ion detector at different times, wherein the time at which an ion arrives at the detector is related to its mass to charge ratio. The mass to charge ratio of a given ion can be determined from the duration of time between the time at which it was pulsed into the time of flight region and the time at which it was detected by the ion detector. The TOF mass analyser 6 is therefore able to obtain data from the signal detected at the detector and determine the mass to charge ratios of the ions pulsed into the mass analyser 6 and their intensities and form a mass spectrum.

The ions may be reflected by one or more ion mirror between the pusher and the ion detector in order to provide a relatively long flight path through the time of flight region. This enables ions of different mass to charge ratios to separate out to a greater degree as they travel though the time of flight region and hence provides the TOF mass analyser 6 with a higher mass resolution. The TOF mass analyser 6 may therefore be a Multi-Reflecting TOF (MRTOF) mass analyser that reflects the ions multiple times using ion mirrors as the ions drift from the pusher towards the ion detector.

The fragment or product ions that are derived from any given species of precursor ion arrive at the TOF mass analyser 6 within a restricted time period that is related to the time period over which their precursor species exit the separator 3.

FIG. 4 shows an example of how fragment or product ions are mass analysed by a TOF mass analyser according to a conventional (non-Encoded Frequent Pulsing) approach. In this example, three species of fragment or product ions having three different mass to charge ratios are generated from a single precursor species within the fragmentation or reaction device 5 and are then transmitted to the TOF mass analyser 6 over the same time period. The three species of fragment or product ions arrive at the pusher of the TOF mass analyser 6 over the time window 8 shown in FIG. 4. The TOF mass analyser 8 periodically pulses the pusher, which therefore repeatedly samples the fragment or product ions throughout time window 8 and mass analyses them. The times at which the TOF pusher is pulsed are illustrated by the vertical lines 10 on the x-axis. These multiple pulses 10 of the TOF pusher during duration 8 cause multiple TOF mass spectra to be generated for the fragment or product ions derived from each precursor ion. Although FIG. 4 only shows the fragment or product ions from one of the precursor species transmitted by the filter 4, it will be appreciated that the fragment or product ions derived from the other precursor ion species that are transmitted by the filter 4 (at respective later or earlier times to said one of the species) will also be mass analysed in the TOF mass analyser 6 in a corresponding manner (at a later or earlier time respectively). This conventional data acquisition scheme has proven useful, e.g. as it enables accurate measurements to be made in the separation time domain of separator 3, and hence ultimately allowing physicochemical properties such as the ion mobility and collision cross section to be determined. This approach also allows processing software to group together the fragment or product ions that are common to the same precursor species.

However, the approach illustrated by FIG. 4 provides the TOF mass analyser 6 with a relatively low TOF sampling duty cycle. This is because a relatively long duration is provided between any given pusher pulse 10 and the next pusher pulse, in order to allow time for the heaviest mass to charge ratio ion pushed by said given pusher pulse to arrive at the ion detector of the TOF analyser 6 before another packet of ions is pushed toward the ion detector by said next pusher pulse. This means that the duration between the pusher pulses 10 is equal to or greater than the time of flight from the pusher to the detector of the maximum mass to charge ratio that is desired to be detected. As such, the sampling duty cycle reduces with the square root of the maximum mass to charge ratio that is desired to be detected. The TOF sampling duty cycle according to such techniques is typically in the range of from 0.1% to 50%. These values are typical maximum duty cycles.

In order to increase the sampling duty cycle of the TOF mass analyser 6, it is known to use an Encoded Frequent Pulsing (EFP) technique that operates the pusher such that the duration between adjacent pulses 10 of the pusher is less than the flight time of the heaviest mass to charge ratio desired to be analysed. In such a technique, the pusher is controlled so as to perform a sequence of consecutive pushes that are arranged in time such that the duration between any pair of pushes in the sequence is different to the duration between any other pair of pushes within the sequence. The sequence of pushes may be repeated one or more times during the mass analysis. Although ions of interest pulsed into the TOF mass analyser 6 by different pushes will arrive at the TOF detector in overlapping time periods according to this EFP technique, the TOF mass analyser is able to decode the resulting data using a decoding algorithm so as to determine which data relates to each push by using the timings of the pushes in the sequence of pushes (since the duration between any pair of pushes in the sequence is unique). As such, the TOF mass analyser 6 is able to covert the data into mass spectral data that is representative of a mass spectrum of the ions detected.

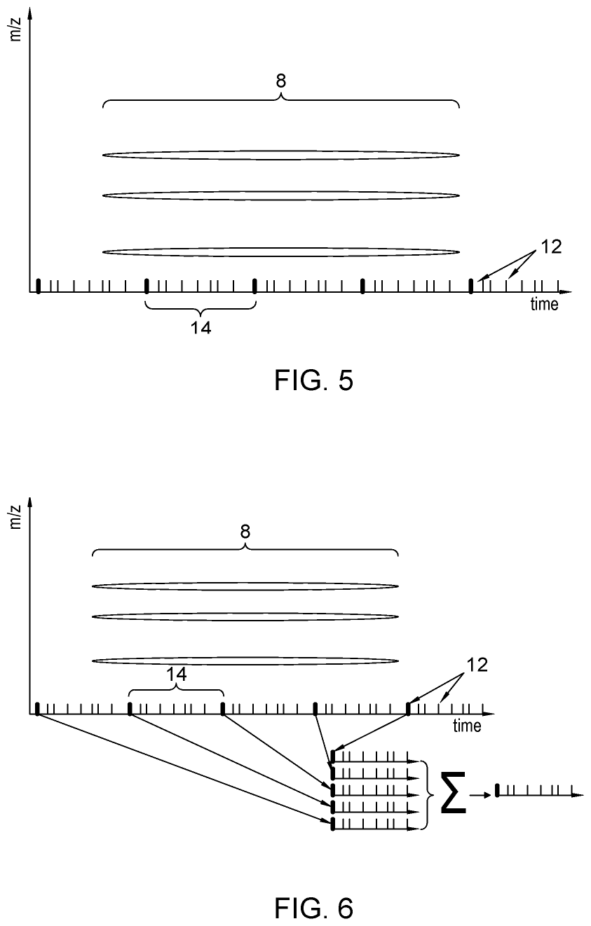

FIG. 5 shows the same example that is shown in FIG. 4, but using an EFP technique to control the pusher of the TOF mass analyser 6. The times at which the pusher is pulsed is illustrated by the vertical lines 12 on the x-axis. The pusher is controlled so as to perform a pulse sequence of consecutive pushes during a pulse sequence time period 14, wherein all of these pushes 12 are arranged in time such that the duration between any pair of pushes in the pulse sequence (i.e. within the pulse sequence time period 14) is different to the duration between any other pair of pushes within the pulse sequence. The same pulse sequence may be repeated in consecutive pulse sequence time periods 14. In FIG. 5 the first push in each pulse sequence is highlighted by being illustrated as a thicker vertical line than the other pushes in the pulse sequence. In this example, the pusher is controlled so as to perform a pulse sequence of eight consecutive pushes within each pulse sequence time period 14. However, it will be appreciated that each pulse sequence may consist of more or less than eight pushes.

It is contemplated the start pushes of adjacent pulse sequences may be closer together or further apart than shown. For example, the first push of each pulse sequence in FIG. 5 is selected to coincide with one of the pushes 10 shown in FIG. 4, but this is for illustrative purposes only and need not be the case. However, desirably the start pushes of adjacent pulse sequences are spaced apart in time by an amount corresponding to, or larger than, the time of flight from the pusher to the detector of the greatest mass to charge ratio that is desired to be mass analysed by the TOF mass analyser (e.g. that is pulsed by the pusher).

It will be appreciated that in the example shown in FIG. 5 there are eight times more pushes than in the example shown in FIG. 4. Accordingly, this increases the sampling duty cycle of the TOF mass analyser by a factor of eight.

As described above, each sequence of pushes 12 is performed over a pulse sequence time period 14. Data obtained by the TOF mass analyser 6 during this pulse sequence time period 14 may later be decoded by a decoding algorithm, in order to obtain mass spectral data that is representative of a mass spectrum of the ions detected by the detector.

It has been recognised that although EFP techniques help increase the sampling duty cycle of the TOF mass analyser 6, problems can arise due to the manner in which the decoding algorithm operates in order to obtain mass spectral data that is representative of a mass spectrum. More specifically, decoding algorithms define a minimum threshold for the number of ions that are required to be detected at any particular time of flight (from the pusher to the detector) before it is determined that a mass to charge ratio peak is present. Otherwise, the number of ions detected may not be statistically meaningful. For example, the decoding algorithm may define the minimum threshold as 10 ions. If the decoding algorithm then determines that fewer than 10 ions have been detected at any given time of flight within a pulse sequence time period, then the data for those ions will be rejected and will not assigned to a mass to charge ratio.

Embodiments of the present disclosure improve upon such techniques by combining (i.e. summing) the data obtained by the TOF mass analyser 6 from multiple pulse sequence time periods 14 before applying the decoding algorithm to the combined data. The combined data may then be decoded using a decoding algorithm so as to produce mass spectral data that is representative of the mass spectrum of the ions detected. As such, ions that are representative of a mass peak are less likely to be discarded, even if they are present within each pulse sequence time period 14 at a level that is below the minimum threshold set by the decoding algorithm. This is because when the data from the multiple pulse sequence time periods 14 is combined, the number of ions occurring at a given time of flight (i.e. having a given mass to charge ratio) is more likely to increase to being above the minimum threshold required by the decoding algorithm to determine that a mass peak is present.

FIG. 6 illustrates a technique according to an embodiment of the present disclosure. The technique is the same as that described in relation to FIG. 5, except that the data obtained by the TOF mass analyser 6 during multiple pulse sequence time periods 14 is combined (i.e. summed) prior to performing the decoding to obtain mass spectral data representative of a mass spectrum of the detected ions. The data obtained during the multiple pulse sequence time periods 14 may combined to produce a single set of summed mass spectral data, such as a single set of histogrammed data. In the example shown, data from five pulse sequence time periods 14 are combined prior to the decoding, although it will be appreciated that data from a different number of pulse sequence time periods may be combined.

FIG. 6 shows that the fragment or product ions pass to the TOF mass analyser 6 over a time window 8 that spans at a least part of four consecutive pulse sequence time periods 14, and that these ions no longer enter the TOF mass analyser 6 during the fifth pulse sequence time period 14 that is illustrated. However, it may still be desired to combine the data obtained during the fifth pulse sequence time period 14 with the data obtained in all (or a subset) of the first to fourth pulse sequence time periods 14, because ions sampled by pushes in the fourth pulse sequence time period 14 will arrive at the TOF ion detector during the fifth pulse sequence time period 14. Stated in more general terms, TOF data obtained during at least one, or at least some, of the pulse sequence time periods 14 that occur when a first species of fragment or product ions is received in the TOF mass analyser (and mass analysed) may be combined with TOF data obtained during the first pulse sequence time period 14 that begins after the time that said first species of fragment or product ions stop entering the TOF mass analyser 6. This combined data is then decoded.

When summing the TOF data obtained during the pulse sequence time periods 14, prior to decoding it, it may be desired not to include TOF data obtained in the last of the pulse sequence time periods 14 that ends before said first species of fragment or product ions start to enter the TOF mass analyser 6. This helps ensure that TOF data related to ions other than the first species of fragment or product ions is not included in the combined data. Although data relating to a first species of fragment or product ion has been described as being obtained and combined, it will be appreciated from the above description that multiple fragment or product ions may be generated from the same precursor species and that these multiple fragment or product ions may arrive at the TOF mass analyser 6 during the same time window 8. As such, data relating to all of these multiple species of fragment or product ion may be obtained and combined in the manner described above.

Although FIG. 6 illustrates an example of how the fragment or product ions derived from a first species of precursor ion may be mass analysed in the TOF mass analyser 6, it will be appreciated that the TOF mass analyser 6 may also mass analyse the fragment or product ions derived from other species of precursor ions that are received at the TOF mass analyser 6 (at an earlier or later time) in a corresponding manner. For example, the fragment or product ions derived from a second, different precursor ion will arrive at the TOF mass analyser over a different, later time window (e.g. as represented by FIG. 3).

These fragment or product ions may then be analysed in a corresponding manner to that described in relation to FIG. 6.

In order to determine which pulse sequence time periods 14 to use when summing the TOF data for fragment or product ions derived from a precursor species, the method disclosed herein may first identify the time window over which these fragment or product ions enter the TOF mass analyser 6. This may be performed by conducting a survey scan to determine the time windows that the various different fragment or product ions arrive at the TOF mass analyser 6. For example, the survey scan may include an MS scan to determine which precursor ions are present in the analytical sample. The survey scan may then perform the method described in relation to FIGS. 1-4, wherein the filter 4 is controlled to transmit different ones of the precursor ions that were detected in the MS scan at different times. Alternatively, the survey scan may perform the method described in relation to FIGS. 1-4 without first performing an MS scan for determining which precursor ions are present in the analytical sample. Furthermore, it is contemplated that the ions need not be fragmented or reacted during the survey scan, but that instead the precursor ions may be detected by the TOF mass analyser, since the time windows that the precursor ions are detected over will correspond to the time windows that their fragment or product ions are detected over.

During the survey scan, the TOF mass analyser 6 may be operated in a non-EFP mode, i.e. where the duration between consecutive pusher pulses is equal to or greater than the time of flight from the pusher to the detector of the maximum mass to charge ratio that is desired to be mass analysed, e.g. as described in relation to FIG. 4. The resulting TOF data may then be used to determine the time window over which fragment or product ions derived from each precursor ion transmitted by the filter 4 would arrive at the TOF mass analyser 6.

The method described in relation to FIGS. 1-3 may then be performed again and the resulting fragment or product ions may be mass analysed according to the EFP technique described in relation to FIG. 6, i.e. where TOF data obtained during multiple pulse sequence time periods 14 is combined before being decoded. As the time window over which each species of fragment or product ion arrives at the TOF mass analyser 6 is known from the survey scan, the mass analyser 6 is able to use this information to determine the timings of the pulse sequence time periods 14 that occur whilst the fragment or product ion species of any given precursor ion species arrive at the TOF mass analyser 6. The mass analyser 6 then selects and combines the TOF data obtained during all, or a subset, of these pulse sequence time periods 14. The mass analyser 6 may also combine with this data the TOF data obtained during the first pulse sequence time period 14 that begins after the time that these fragment or product ion species stop entering the TOF mass analyser 6. The combined data is then decoded as described herein.

Techniques have been described above in which the TOF data that is combined (prior to decoding) is the TOF data obtained from product or fragment ions derived from only a single precursor ion species that is transmitted during only a single separation cycle of the separator 3. In other words, the TOF data that is summed (prior to decoding) is the TOF data obtained during the elution of a single precursor species from a single separation cycle of the separator 3. However, it is also contemplated that the TOF data that is combined (prior to decoding) may be the TOF data obtained during the elution times of the same single precursor ion species, during multiple separation cycles of the separator 3. This TOF data obtained from the multiple separation cycles may be combined and then decoded. This serves to combine a relatively high amount of spectral data before the combined data is decoded using a decoding algorithm, thereby overcoming the problem described above with the minimum threshold set by the decoding algorithm.

According to these techniques, a survey scan may be performed, e.g. in the same manner as described above. The survey scan may be used to determine the time window over which a precursor species of interest arrives at the TOF mass analyser 6, relative to the start time of the separation cycle of the separator (e.g. relative to the time that the ion packet is pulsed into the separator 3). Alternatively, the survey scan may be used to determine the time window over which the fragment/product ions of the precursor ions species of interest arrive at the TOF mass analyser 6 (e.g. relative to the start time of the separation cycle of the separator).

The method described in relation to FIGS. 1-3 may then be performed and the resulting fragment or product ions may be mass analysed according to the EFP technique described in relation to FIG. 6. In other words, a packet of precursor ions is separated in separator 3, filtered by mass filter 4, fragmented or reacted in fragmentation or reaction device 5, and then the resulting fragment or product ions are mass analysed by the TOF mass analyser 6. As the time window over which the fragment or product ions derived from the precursor ion species of interest arrive at the TOF mass analyser 6 is known from the survey scan, the mass analyser 6 is able to use this information to determine the timings of the pulse sequence time periods 14 that occur whilst these fragment or product ion species arrive at the TOF mass analyser 6. The mass analyser 6 then selects the TOF data obtained during all, or a subset, of these pulse sequence time periods 14 for combining with other data. As described above, the mass analyser 6 may also select, for summing with the other data, the TOF data obtained during the first pulse sequence time period 14 that begins after the time that these fragment or product ion species stop entering the TOF mass analyser 6.

The method described above is then repeated, by pulsing another packet of precursor ions into the separator 3, separating the precursor ions in separator 3, filtering the ions eluting from the separator 3 using mass filter 4, fragmenting or reacting the filtered ions in fragmentation or reaction device 5, and then mass analysing the resulting fragment or product ions in the TOF mass analyser 6. The mass analyser 6 then, again, selects the portion of the TOF data corresponding to the fragment or product ions derived from the precursor ion species of interest and combines it with the TOF data that had been selected previously.

The method described above may be repeated as many times as desired, and each time the TOF data corresponding to the fragment or product ions derived from the precursor ion species of interest is combined with the TOF data that had been selected previously. After this, the combined data may be decoded so as to obtain mass spectral data.

In the embodiments described above, each species of fragment or production has been described as arriving at the TOF mass analyser 6 over a time window that is longer than a pulse sequence time period 14, e.g. over a time period that is longer than the time of flight from the pusher to the detector of the greatest mass to charge ratio that is desired to be mass analysed by the TOF mass analyser 6. However, some species of fragment or product ions may arrive at the TOF mass analyser 6 over a time window that is shorter than a pulse sequence time period 14. This may occur, for example, because the precursor species of such fragment or product species elutes from the separator 3 over a relatively short duration.

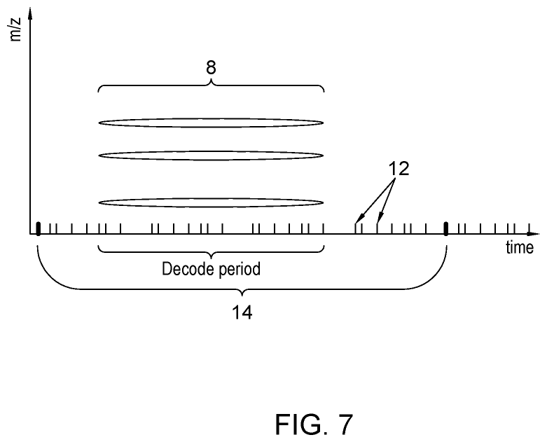

FIG. 7 shows an example where three species of fragment or product ion (derived from the same precursor) arrive at the TOF mass analyser 6 over a time window 8 that is shorter a pulse sequence time period 14. As described above, the TOF mass analyser 6 is operated according to an EFP technique. Although the number of pushes 12 in each pulse sequence time period 14 is different to that shown in FIG. 6, this is for illustrative purposes only and, as described above, each pulse sequence time period 14 may include any desired number of pushes 12.

It has been recognised that where a species of ion arrives at the TOF mass analyser 6 over a time window 8 that is shorter than the pulse sequence time period 14, then not only is it desired to not combine TOF data obtained during multiple pulse sequence time periods 14 prior to the decoding step, but it may also not be desired to combine all of the TOF data obtained in a single pulse sequence time period 14 prior to the decoding step. For example, combining the TOF data obtained over the whole pulse sequence time period 14 will include more noise data than is necessary, since the ions are not present in the TOF mass analyser 6 during the whole pulse sequence time period 14.

According to embodiments of the present disclosure, in such situations the TOF data obtained during only a portion of a pulse sequence time period 14 is combined prior to decoding. For example, the TOF data obtained during a portion of the pulse sequence time period 14 that corresponds to at least part of the duration that the species of ion enters the TOF mass analyser 6 may be combined, and then decoded. Less preferably, the TOF data obtained during the pulse sequence time period 14 after the species of ion stops entering the TOF mass analyser 6 may also be combined, prior to the decoding step, since the species may still be received at the TOF detector during at least some of this time.

The duration over which the species of ions enters the TOF mass analyser 6 may be determined from a survey scan, in a corresponding manner to the survey scan discussed above. The mass analyser 6 is therefore able to use this information to determine the pulse sequence time period 14 within which the species will arrive at the TOF detector and the duration over which the data should be summed.

Although the present invention has been described with reference to preferred embodiments, it will be understood by those skilled in the art that various changes in form and detail may be made without departing from the scope of the invention as set forth in the accompanying claims.

For example, although the mass filter 4 has been described as being stepped between different, discrete mass transmission windows as the ions elute from the separator 3, it is contemplated that the mass filter 4 may instead have a mass transmission window that is progressively scanned. For example, the mass transmission window may increase by one mass to charge ratio unit at a time. Alternatively, the mass filter 4 may have a mass transmission window that is configured to be able to simultaneously transmit a range of mass to charge ratios (e.g. a range consisting of multiple Da). This mass transmission window may be progressively scanned such that each time the mass transmission window is moved for transmitting a new mass range, the new mass range still partially overlaps with the previous mass range that the filter 4 had been configured to transmit.

Alternatively, or additionally, although the filter 4 has been described as a mass to charge ratio filter, it is contemplated that the filter may filter ions according to another physicochemical property such as ion mobility or FAIMS etc.

Alternatively, or additionally, although the separator 3 has been described as an ion mobility separator, it is contemplated that the separator may separate ions according to another physicochemical property such as mass to charge ratio.

Furthermore, although the techniques described herein have been described in relation to summing and decoding TOF data relating to detected fragment or product ions, it is contemplated that the TOF data may instead relate to precursor ions (i.e. analyte ions that have not been fragmented or reacted to form different ions). Alternatively, or additionally, it is contemplated that the techniques described herein could be performed without separating and/or filtering the ions.

1. A method of mass spectrometry comprising:
a) providing a mass spectrometer having an ion separator for separating ions according to a physicochemical property, and a time of flight (TOF) mass analyser having an ion detector and a pusher that, when pulsed, pushes ions into a time of flight region to a detector;
b) performing a survey scan comprising: performing a separation cycle during which a packet of precursor ion species is separated in the ion separator such that precursor ion species having different values of the physicochemical property elute from the ion separator at different times; and then mass analysing the separated precursor ion species, or fragment or product ions derived therefrom, in the TOF mass analyser so as to obtain first mass spectral data;
c) determining, from the first mass spectral data, a time window over which one of the precursor ion species, or fragment or product ions derived therefrom, were mass analysed by the TOF mass analyser;
d) performing another separation cycle during which another packet of precursor ion species is separated in the ion separator such that precursor ion species having different values of the physicochemical property elute from the ion separator at different times; and then
e) mass analysing the precursor ion species separated in step d), or fragment or product ions derived therefrom, in the TOF mass analyser so as to obtain second mass spectral data, wherein this mass analysing comprises pulsing the pusher according to a plurality of consecutive pulse sequences during a plurality of respective pulse sequence time periods, wherein each pulse sequence consists of consecutive pushes that are arranged such that the duration between any pair of pushes in the pulse sequence is different to the duration between any other pair of pushes within the pulse sequence;
f) selecting mass spectral data, from the second mass spectral data, that was obtained during a time period corresponding to said time window of the survey scan, so as to obtain selected data;
g) repeating steps d) to f) at least one further time such that multiple sets of said selected data are obtained;
h) combining said multiple sets of selected data so as to obtain combined data; and then
i) decoding the combined data to obtain mass spectral data representative of the mass to charge ratios of the ions detected by the TOF mass analyser.

2. The method of claim 1, wherein step c) comprises determining a first time delay between the start time of the separation cycle in the survey scan and the start time of said time window; and wherein the method comprises setting said time period in step f) to begin after a second time delay from the start time of said another separation cycle in step d), wherein said first time delay is the same as the second time delay.

3. The method of claim 1, wherein said time window has the same duration as said time period in step f).

4. The method of claim 1, wherein the selected mass spectral data obtained in step f) includes mass spectral data obtained during multiple different ones of the pulse sequence time periods of step e).

5. The method of claim 1, wherein the combined data is decoded based on knowledge of the pulse sequence used in each of said plurality of pulse sequence time periods.

6. The method of claim 1, wherein said decoding assigns data corresponding to ions that have been detected to mass to charge ratios, and determines that a mass to charge ratio peak has been detected only when more than a threshold number of ions are assigned to a given mass to charge ratio.

7. The method of claim 1, comprising fragmenting or reacting precursor ion species in a fragmentation or reaction device between steps d) and e) so that said mass analysing in step e) comprises mass analysing the resulting fragment or product ions.

8. The method of claim 1, comprising providing a mass filter that filters ions between the ion separator and the fragmentation or reaction device so as to only transmit ions having a restricted value, or range of values, of mass to charge ratio at any given time; and controlling the mass filter to vary said value, or range of values, as ions elute from the ion separator so as to transmit different species of ions towards the fragmentation or reaction device at different times.

9. The method of claim 8, wherein the mass filter is controlled to vary said value, or range of values, over a cycle time that is synchronised with the separation cycle of step d).

10. The method of claim 1, wherein the first physicochemical property is ion mobility.

11. The method of claim 1, wherein during the survey scan of step b) said mass analysing comprises pulsing the pusher in a manner such that the duration between any pair of adjacent pusher pulses is equal to or greater than the time of flight from the pusher to the detector of the maximum mass to charge ratio ions that are pushed by the pusher.

12. A mass spectrometer comprising:
an ion separator for separating ions according to a physicochemical property;
a time of flight (TOF) mass analyser having an ion detector and a pusher that, when pulsed, pushes ions into a time of flight region to a detector; and
control circuitry configured to perform the method of claim 1.

13. A method of mass spectrometry comprising:
providing a time of flight (TOF) mass analyser having an ion detector and a pusher that, when pulsed, pushes ions into a time of flight region to the detector;
mass analysing ions in the TOF mass analyser so as to obtain data relating to the ions, wherein said mass analysing comprises pulsing the pusher according to a pulse sequence that consists of consecutive pushes that are arranged such that the duration between any pair of pushes in the pulse sequence is different to the duration between any other pair of pushes within the pulse sequence;
determining that one or more species of ions arrive at the TOF mass analyser during only a portion of one or more of the pulse sequence time periods;
combining only data obtained by the mass analyser during said portion of the one or more pulse sequence time periods; and
decoding this combined data.

14. The method of claim 13, comprising performing a survey scan, prior to said step of mass analysing ions, in which said one or more species of ions are mass analysed by the TOF mass analyser;
determining a time window over which the one or more species of ions arrive at the TOF mass analyser from the survey scan; and
using said time window to determine the portion of the one or more of the pulse sequence time periods during which the one or more species of ions arrive at the TOF mass analyser.

15. A TOF mass analyser comprising:
an ion detector and a pusher that, when pulsed, pushes ions into a time of flight region to the detector; and
control circuitry configured to:
mass analyse ions, so as to obtain data relating to the ions, by pulsing the pusher according to a plurality of consecutive pulse sequences during a plurality of respective pulse sequence time periods, wherein each pulse sequence consists of consecutive pushes that are arranged such that the duration between any pair of pushes in the pulse sequence is different to the duration between any other pair of pushes within the pulse sequence;
determine that one or more species of ions arrive at the TOF mass analyser during only a portion of one or more of the pulse sequence time periods;
combine only data obtained by the mass analyser during said portion of the one or more pulse sequence time periods; and
decode the combined data to obtain mass spectral data representative of the mass to charge ratios of the one or more species.

16. (canceled)
